(19) United States
(12) Patent Application Publication
(10) Pub. No.: US 2012/0249886 A1
(43) Pub. Date: Oct. 4, 2012

(54) LIGHTING DEVICE, DISPLAY DEVICE AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/515,360

(22) PCT Filed: Nov. 9, 2010
(86) PCT No.: PCT/JP2010/069912

§ 371 Date: Jun. 12, 2012

(30) Foreign Application Priority Data
Dec. 16, 2009 (JP) 2009-285346

(51) Int. Cl. H04N 5/44; G02F 1/13357; F21V 8/00

(52) U.S. Cl. 348/725; 362/602; 362/612; 362/611; 362/613; 349/62; 348/E05.096

(57) ABSTRACT

A backlight unit includes LED boards, LED light sources disposed on a surface of the LED boards, a light guide plate, and spacer members. The light guide plate guides light from the LED light sources. The spacer members regulate the distance between the LED boards and the light guide plate. In the backlight unit, the distance between the light guide plate and the LED boards, and warping or floating of the LED boards are regulated by the spacer members, and therefore, a constant distance can be maintained between the LED board and the light guide plate.

### TECHNICAL FIELD

The present invention relates to a lighting device, a display device and a television receiver.

### BACKGROUND ART

In recent years, display elements of image display devices such as television receivers have been in a period of transition from the conventional cathode-ray tubes to flat display devices using flat display elements, such as a liquid crystal panel or a plasma display panel, enabling a decrease in thickness of the image display device. A liquid crystal display device requires a backlight unit as a separate lighting device because a liquid crystal panel used in the display device does not emit light by itself.

Patent Document 1 discloses a backlight unit provided with alight guide plate having a light entrance surface on a side surface thereof; alight source facing the light entrance surface of the light guide plate; and a frame in which the light guide plate and the light source are disposed. In this backlight unit, a support portion for regulating the movement of the light guide plate toward the light source is integrally formed with the frame at a position between the light source and the light guide plate. Thus, the light entrance surface of the light guide plate is regulated by the support portion as the light guide plate is thermally expanded toward the light source due to heat generated upon emission of light from the light source, for example.

Patent Document 1: Japanese Unexamined Patent Publication No. 2009-238567

### Problem to be Solved by the Invention

A light source board with a plurality of light sources arranged on a surface thereof may be adopted so as to provide the light sources as a unit. According to Patent Document 1, when the backlight unit is provided with such a light source board with a plurality of light sources disposed thereon, the light source board is not regulated by the support portion. As a result, when heat is generated upon emission of light from the light source, for example, the light source board may be thermally deformed, resulting in warping or floating of the light source board. When there is warping or floating in the light source board, the distance between the light sources and the light guide plate may be greatly changed, thereby making it difficult to maintain the optical design of the backlight unit.

### DISCLOSURE OF THE PRESENT INVENTION

The present invention was made in view of the foregoing circumstances. An object of the present invention is to provide a technology that makes it possible to maintain the optical design of a lighting device provided with a light source board on which a light source is disposed upon thermal expansion of a light guide plate or thermal deformation of the light source board due to heat generated upon emission of light from the light source, for example.

Another object of the present invention is to provide a display device including such a lighting device, and a television receiver including such a display device.

### Means for Solving the Problem

A technology disclosed in the present specification relates to a lighting device including a light source board; a light source disposed on a surface of the light source board; a light guide plate configured to guide light from the light source; and a spacer member configured to regulate a distance between the light source board and the light guide plate.

According to the above lighting device, when the light guide plate is subjected to thermal expansion, the distance between the light source board and the light guide plate is regulated by the spacer member. When the light source board is subjected to thermal deformation, warping or floating of the light source board is regulated by the spacer member. Thus, a constant distance can be maintained between the light source and the light guide plate even when heat is generated around the light source upon emission of light from the light source, for example. Accordingly, the optical design of the lighting device can be maintained.

The light guide plate may include a light entrance surface on a side thereof, the light source board may face the light entrance surface of the light guide plate, and the spacer member may be in contact with the light entrance surface of the light guide plate. According to this configuration, when the light guide plate is subjected to thermal expansion, the light entrance surface of the light guide plate is regulated by the spacer member. Thus, a constant distance can be maintained between the light source and the light guide plate. Accordingly, the optical design of the lighting device can be maintained with high accuracy.

The spacer member may be in contact with the surface of the light source board. According to this configuration, because the spacer member is in contact with the surface of the light source board, warping or floating of the light source board upon thermal deformation of the light source board is regulated by the spacer member. Thus, a constant distance can be maintained between the light source and the light guide plate. Accordingly, the optical design of the lighting device can be maintained with high accuracy.

The spacer member may have a coefficient of linear expansion smaller than a coefficient of linear expansion of the light guide plate. According to this configuration, the coefficient of thermal expansion of the spacer member is smaller than the coefficient of thermal expansion of the light guide plate. Therefore, the distance between the light source board and the light guide plate, and warping or floating of the light source board can be effectively regulated by the spacer member.

The spacer member may include a surface facing the light source board and parallel to the light source board. According to this configuration, the spacer member and the light source board are in surface to surface contact with each other. Therefore, a large area of contact between the spacer member and the light source board is obtained. Thus, warping or floating of the light source board can be effectively regulated by the spacer member.

The spacer member may include a pointed tip portion, and the pointed tip portion may face the light guide plate. When the spacer member is in contact with the light guide plate, some of the light incident on the light guide plate from the light source may be blocked by the spacer member, resulting in the formation of a dark portion in the light guide plate. According to the above configuration, the spacer member is in contact with the light guide plate via the pointed tip portion, and therefore, the area of contact between the spacer member and the light guide plate is decreased. Thus, the range (area) of the dark portion that could be formed in the light guide plate can be decreased. Accordingly, the optical design of the lighting device can be maintained with high accuracy.

The light source may include a plurality of light sources disposed parallel to each other on the light source board, and the spacer member may be disposed between the adjacent light sources. When a plurality of light sources is disposed parallel to each other on the surface of the light source board, a dark portion may be formed on the side surface of the light guide plate, the side surface facing a surface between the adjacent light sources. According to the above configuration, the area of contact between the spacer member and the light guide plate is decreased. Thus, the range (area) of the dark portion that could be formed in the light guide plate can be decreased, and therefore, the optical design of the lighting device can be maintained with high accuracy.

The spacer member may include a surface facing the light guide plate and parallel to the light guide plate. According to this configuration, since the spacer member is contact with the surface of the light guide plate, a large area of contact is obtained between the spacer member and the light guide plate. Thus, the distance between the light source board and the light guide plate can be effectively regulated by the spacer member.

The lighting device may further include a retainer member configured to retain at least the light source and the light guide plate. The spacer member may be fixed to the retainer member through the light source board. According to this configuration, the spacer member can be stably disposed between the light source board and the light guide plate. Thus, the distance between the light source board and the light guide plate, and warping or floating of the light source board can be effectively regulated by the spacer member.

The lighting device may further include a retainer member configured to retain at least the light source and the light guide plate. The spacer member may be disposed only on a surface of the retainer member positioned between the light source board and the light guide plate and fixed to the chassis. The light guide plate may include a light exit surface on a plate surface thereof and through which light from the light source entered via the light entrance surface exits to the outside, and an opposite surface on a side opposite to the light exit surface. The spacer member may be fixed to a surface of the retainer member on a side of the light exit surface with respect to the light source. The spacer member may be fixed to a surface of the retainer member closer to the opposite surface opposite to the light source. According to these configurations, the spacer member can be stably disposed between the light source board and the light guide plate. Thus, the distance between the light source board and the light guide plate, and warping or floating of the light source board can be effectively regulated by the spacer member. A plurality of light sources can be continuously disposed on the surface of the light source board because the spacer member is not disposed on the surface of the light source board.

The light source may be a light-emitting diode. According to this configuration, long operating life of the light source can be obtained and low power consumption can be achieved.

The light-emitting diode may be a blue light emitting element coated with a phosphor with an emission peak in a yellow region so as to emit white light. The light-emitting diode may be a blue light emitting element coated with a phosphor with emission peaks in green and red regions so as to emit white light. The light-emitting diode may be a blue light emitting element coated with a phosphor with an emission peak in a green region and combined with a red light emitting element so as to emit white light. The light-emitting diode may be a blue light emitting element combined with a green light emitting element and a red light emitting element so as to emit white light. According to these configurations, a generally averaged color tone can be obtained such that illumination light with substantially uniform color tone can be obtained.

The light-emitting diode may be an ultraviolet light emitting element combined with a phosphor. The light-emitting diode may be an ultraviolet light emitting element coated with a phosphor with emission peaks in blue, green, and red so as to emit white light. According to these configurations, a generally averaged color tone can be obtained such that illumination light with a substantially uniform color tone can be obtained.

The lighting device may further include a heat dissipating plate disposed on a back surface side of the light source. According to this configuration, heat generated around the light source can be effectively dissipated to the outside of the lighting device by the heat dissipating plate. Thus, the amount of heat transmitted to the light guide plate can be decreased, and therefore, thermal expansion of the light guide plate or thermal deformation of the light source board can be decreased.

The technologies disclosed in the present specification may be a display device including a display panel displaying by utilizing light from the lighting device. A novel and useful display device may include the display panel as a liquid crystal panel using liquid crystal. A novel and useful television receiver may include the display device. According to the above display device and the television receiver, a large area display region can be realized.

### Advantageous Effect of the Invention

According to the technologies disclosed in the present specification, the optical design of a lighting device including a light source board on which a light source is disposed can be maintained even when a light guide plate is subjected to thermal expansion or the light source board is subjected to thermal deformation due to heat generated upon emission of light from the light source.

### BRIEF DESCRIPTION OF THE DRAWINGS

FIG. 1 is an exploded perspective view of a television receiver TV according to a first embodiment;

FIG. 2 is an exploded perspective view of a liquid crystal display device 10;

FIG. 3 is a horizontal cross section view of the liquid crystal display device 10;

FIG. 4 is an enlarged cross section view of the liquid crystal display device 10 around a spacer member 20;

FIG. 5 is an enlarged cross section view of a liquid crystal display device 10 around a spacer member 20 according to a second embodiment;

FIG. 6 is an enlarged cross section view of a liquid crystal display device 10 around a spacer member 40 according to a third embodiment;

FIG. 7 is an enlarged cross section view of a liquid crystal display device 10 around a spacer member 50 according to a fourth embodiment;

FIG. 8 is an enlarged cross section view of a liquid crystal display device 10 around spacer members 60 and 70 according to a fifth embodiment;

FIG. 9 is an enlarged cross section view of a liquid crystal display device 10 around a spacer member 80 according to a sixth embodiment; and

FIG. 10 is an enlarged cross section view of a liquid crystal display device 10 around a spacer member 90 according to a seventh embodiment.

### BEST MODE FOR CARRYING OUT THE INVENTION

### First Embodiment

With reference to the drawings, an embodiment will be described. In some parts of the drawings, an X-axis, a Y-axis, and a Z-axis are shown, where the directions of the axes are common among the drawings. The Y-axis direction corresponds to a vertical direction and the X-axis direction corresponds to a horizontal direction. References to “top” and “bottom” will be with respect to the vertical direction unless otherwise noted.

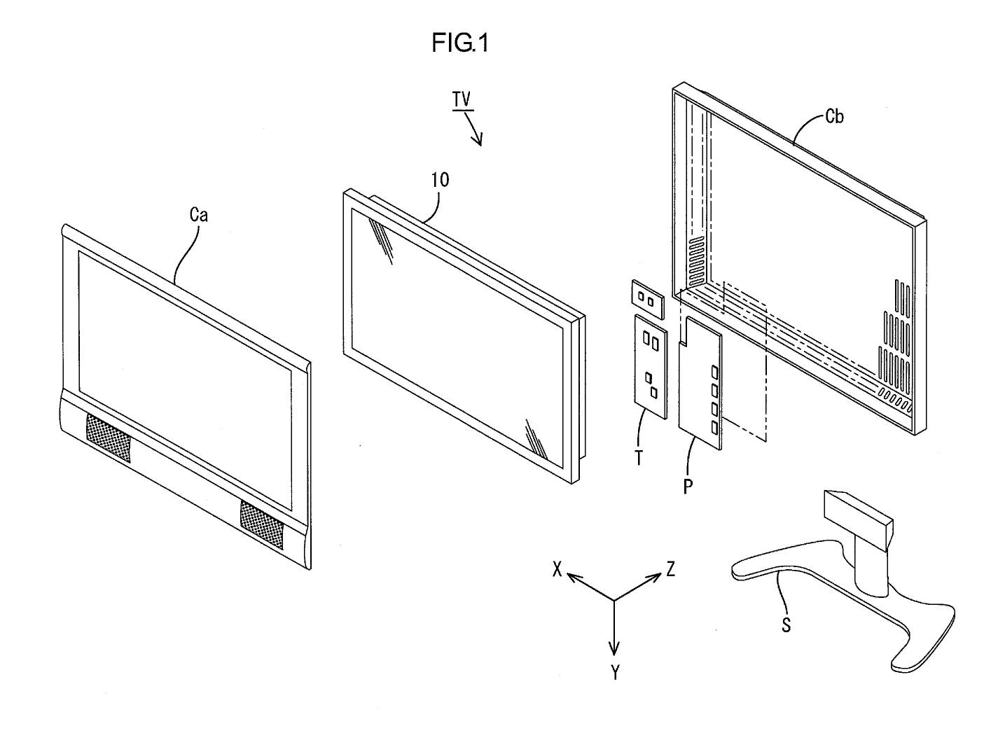

FIG. 1 is an exploded perspective view of a television receiver TV according to a first embodiment. As illustrated in FIG. 1, the television receiver TV includes a liquid crystal display device 10, front and back cabinets Ca and Cb sandwiching the liquid crystal display device 10 therebetween, a power source P, a tuner T, and a stand S.

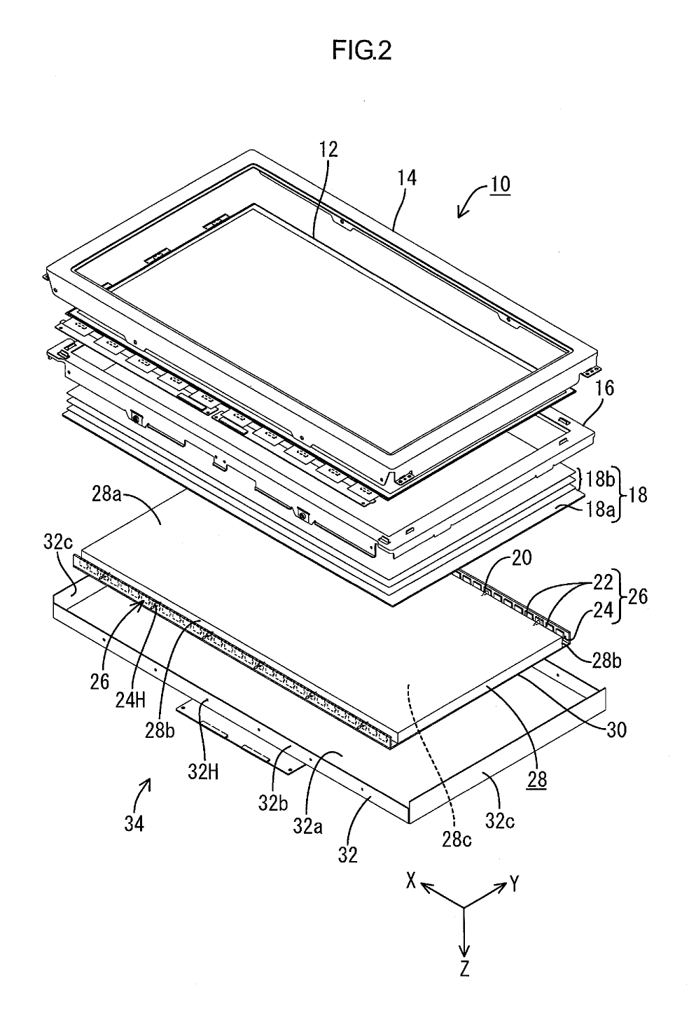

FIG. 2 is an exploded perspective view of the liquid crystal display device 10. The upper side and lower side of FIG. 2 correspond to a “front side” and a “back side”, respectively. As illustrated in FIG. 2, the liquid crystal display device 10 has a generally oblong square shape and includes a liquid crystal panel 12 as a display panel and a backlight unit 34 as an external light source, which are integrally held by a frame-shaped bezel 14 and the like.

As illustrated in FIG. 2, the liquid crystal panel 12 of the liquid crystal display device 10 has a rectangular shape in plan view, with a long side direction corresponding to the horizontal direction (X-axis direction) and a short side direction corresponding to the vertical direction (Y-axis direction). The liquid crystal panel 12 includes a pair of transparent (highly light transmissive) glass substrates affixed to each other with a predetermined gap, with a liquid crystal layer (not illustrated) enclosed between the glass substrates. On one glass substrate, switching elements (such as TFTs) connected to source wiring and gate wiring which are orthogonally disposed, pixel electrodes connected to the switching elements, and an alignment film and the like are provided. On the other glass substrate, color filters including color sections of R (red), G (green), and B (blue) disposed in a predetermined arrangement, counter electrodes, and an alignment film and the like are provided. The source wiring, the gate wiring, and the counter electrodes may be supplied with image data or various control signals for displaying an image from a drive circuit board, which is not illustrated. On the outside of each of the glass substrates, a polarizing plate (not illustrated) is disposed.

Next, the backlight unit 34 will be described. As illustrated in FIG. 2, the backlight unit 34 includes a backlight chassis (retainer member) 32, an optical member 18, and a frame (retainer member) 16. The backlight chassis 32 has a substantially box-like shape with an opening on the front side (light output side; the side of the liquid crystal panel 12). The optical member 18 is disposed so as to cover the opening of the backlight chassis 32. The frame 16 has a frame shape and is disposed so as to surround the optical member 18. In the backlight chassis 32, a pair of LED (Light Emitting Diode) units 26 and a light guide plate 28 are housed. The pair of LED units 26 is disposed on the outer ends of the backlight chassis 32 on both long sides thereof and configured to output light. The light guide plate 28 is disposed between the pair of LED units 26 and configured to guide the light output from the LED units 26 toward the liquid crystal panel 12. The optical member 18 is placed on the front side of the light guide plate 28. According to the present embodiment, the backlight unit 34 is of the so-called edge light type (side light type) in which the light guide plate 28 and the optical member 18 are disposed immediately under the liquid crystal panel 12, with the LED units 26 as the light source disposed at the side end portions of the light guide plate 28.

The backlight chassis 32, which may be made of a metal such as an aluminum material, includes a bottom plate 32a having a rectangular shape in plan view, and side plates 32b and 32c rising from the outer ends of the bottom plate 32a on both long sides thereof and both short sides thereof, respectively, toward the front side. The bottom plate 32a has a long side direction corresponding to the horizontal direction (X-axis direction) and a short side direction corresponding to the vertical direction (Y-axis direction). In the backlight chassis 32, a space between the pair of LED units 26 provides the space for housing the light guide plate 28. On the back side of the bottom plate 32a, a power supply circuit board for supplying electric power to the LED units 26 may be mounted. A plurality of first mounting holes 32H1 is formed through the side plates 32b. Each mounting hole 32H1 is formed in an area overlapping a part of the corresponding spacer member 20.

The optical member 18 includes a diffuser plate 18a and an optical sheet 18b. The optical sheet 18b is disposed on the diffuser plate 18a and includes a diffuser sheet, a lens sheet, and a reflection type polarizing plate stacked successively from the side of the diffuser plate 18a. The optical sheet 18b has the function of making the light output from the LED units 26 and transmitted through the diffuser plate 18a into planar light. The liquid crystal panel 12 is installed on the upper surface side of the optical sheet 18b. Thus, the optical sheet 18b is disposed between the diffuser plate 18a and the liquid crystal panel 12.

The LED units 26 include LED boards 24 made of a resin and having a rectangular shape on which LED light sources 22 configured to emit white light and the spacer members 20 are disposed parallel to each other in line. The spacer members 20 are disposed between a plurality of LED light sources 22 at uniform intervals. The spacer members 20 will be described in detail later with reference to other drawings. The pair of LED units 26, 26 may be attached to the outer end portions 32b of the backlight chassis 32 on the long sides thereof via screws and the like, with the LED light sources 22 and the spacer members 20 of one LED unit 26 facing those of the other LED unit 26. A plurality of through holes 24H communicated with the plurality of first mounting holes 32H1 formed in the backlight chassis 32 is formed through the LED boards 24 at positions overlapping with the plurality of first mounting holes 32H1.

The LED light sources 22 may be configured to emit white light by coating a blue light emitting element with a phosphor having an emission peak in a yellow region. The LED light sources 22 may be configured to emit white light by coating a blue light emitting element with a phosphor having emission peaks in green and red regions. The LED light sources 22 may be configured to emit white light by coating a blue light emitting element with a phosphor having an emission peak in a green region and combining the blue light emitting element with a red light emitting element. The LED light sources 22 may be configured to emit white light by combining a blue light emitting element, a green light emitting element, and a red light emitting element. Further, the LED light sources 22 may be configured to emit white light by coating an ultraviolet light emitting element with a phosphor having emission peaks in blue, green, and red.

The light guide plate 28 is a rectangular plate-like member which may be made of a highly light transmissive (highly transparent) resin, such as acrylic resin. As illustrated in FIG. 2, the light guide plate 28 is disposed between the mutually opposed LED units 26, with a main plate surface (light exit surface 28a) facing the diffuser plate 18a. On a surface (opposite surface 28c) of the light guide plate 28 on the side opposite to the surface facing the diffuser plate 18a, a light reflection sheet 30 is provided. The light reflection sheet 30 has the function of reflecting leakage light from the light guide plate 28 back into the light guide plate 28. Thus, the light from the LED units 26 becomes incident on the side plate surfaces (light entrance surfaces 28b) of the light guide plate 28 and output via the main plate surface facing the diffuser plate 18a, and therefore, the liquid crystal panel 12 can be irradiated with the light from a back surface side thereof.

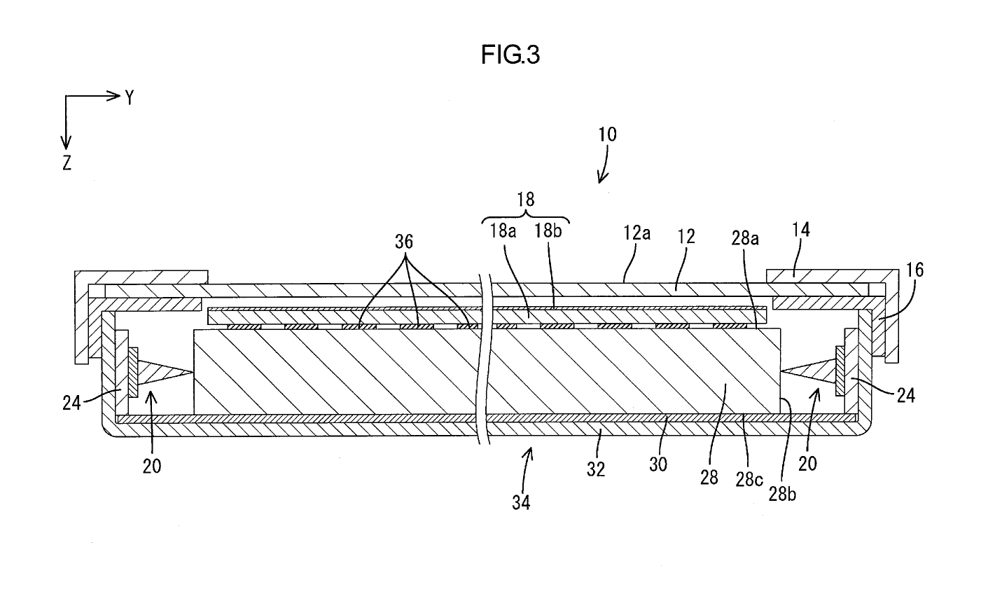

FIG. 3 is a horizontal cross section view of the liquid crystal display device 10. The horizontal cross section view of FIG. 3 illustrates a cross sectional structure of the liquid crystal display device 10 in a cross section taken in an Y-Z plane passing the spacer members 20. As illustrated in FIG. 3, the LED boards 24 and the light guide plate 28 are retained between the frame 16 and the backlight chassis 32. The spacer members 20 are disposed between the LED boards 24 and the light guide plate 28. Though not illustrated in FIG. 3, the spacer members 20 may include penetrating portions penetrating through the LED boards 24 and the backlight chassis 32. On the light exit surface 28a of the light guide plate 28, a plurality of scattering dots 36 are provided. The scattering dots 36 have the function of scattering the light output from the light guide plate 28 toward the diffuser plate 18a.

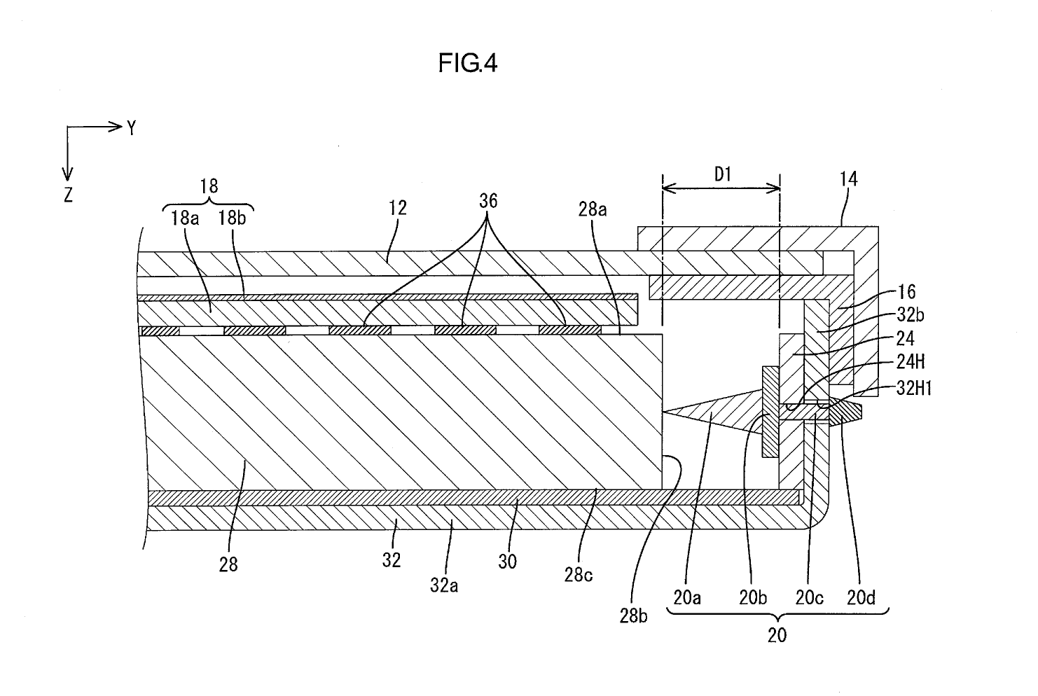

FIG. 4 is an enlarged cross section view of a portion of the horizontal cross section view of FIG. 3 around the spacer members 20. The spacer members 20 are formed of a material (such as a metal) having a coefficient of linear expansion smaller than a coefficient of linear expansion of the light guide plate 28. The spacer members 20 are configured to be fixed to the backlight chassis 32. For example, as illustrated in FIG. 4, the spacer members 20 include a pointed tip portion 20a, abase plate portion 20b, a penetrating portion 20c, and a locking portion 20d. The pointed tip portion 20a has a conical shape with the tip contacting the light entrance surface of the light guide plate 28. The base plate portion 20b has a plate shape and is disposed on a surface of the LED boards 24. The penetrating portion 20c has an axial shape and penetrates the through holes 24H formed in the LED boards 24 and the first mounting holes 32H1 formed in the side plates 32b of the backlight chassis 32. The locking portion 20d is continuous with the penetrating portion 20c and is locked on the side plates 32b of the backlight chassis 32. The spacer members 20 are fixed to the backlight chassis 32 via the penetrating portion 20c and the locking portion 20d. A distance D1 between the LED boards 24 and the light guide plate 28 is regulated by the spacer members 20, and therefore, a constant distance is maintained between the LED light sources 22 and the light guide plate 28.

The television receiver TV according to the present embodiment has been described in detail. In the backlight unit 34 of the television receiver TV according to the present embodiment, the spacer members 20 disposed on the surface of the LED boards 24 are contacted with the light entrance surface of the light guide plate 28. Thus, when the light guide plate 28 is subjected to thermal expansion, the distance D1 between the LED boards 24 and the light guide plate 28 is regulated by the spacer members 20. Further, when the LED boards 24 are subjected to thermal deformation, warping or floating of the LED boards 24 is regulated by the spacer members 20. Accordingly, even when heat is generated around the LED light sources 22 due to the emission of light from the LED light sources 22, for example, a constant distance can be maintained between the LED light sources 22 and the light guide plate 28, and therefore, the optical design of the backlight unit 34 can be maintained with high accuracy.

According to the foregoing embodiment, the coefficient of linear expansion of the spacer members 20 is smaller than the coefficient of linear expansion of the light guide plate 28. Thus, the spacer members 20 have a rate of thermal expansion smaller than a rate of thermal expansion of the light guide plate 28. Accordingly, the distance between the LED boards 24 and the light guide plate 28, and warping or floating of the LED boards 24 can be effectively regulated by the spacer members 20.

According to the foregoing embodiment, the spacer members 20 include the base plate portion 20b facing the LED boards 24 to be parallel such that the spacer members 20 and the LED boards 24 make a surface to surface contact with each other. Thus, a large area of contact is obtained between the spacer members 20 and the LED boards 24. Accordingly, warping or floating of the LED light source 22 can be effectively regulated by the spacer members 20.

According to the foregoing embodiment, the spacer members 20 include the pointed tip portion 20a, which faces the light guide plate 28 and is contacted with the light guide plate 28. Thus, the spacer members 20a and the light guide plate 28 have a small area of contact. Accordingly, the range (area) of a dark portion which could be formed in the light guide plate 28 can be decreased, thereby allowing the optical design of the backlight unit 34 to be maintained with high accuracy.

According to the foregoing embodiment, the LED light sources 22 are disposed parallel to each other on the LED boards 24, and the spacer members 20 are disposed between adjacent LED light sources 22. Thus, the range (area) of a dark portion that could be formed in the light guide plate 28 can be decreased, and therefore, the optical design of the backlight unit 34 can be maintained with high accuracy.

According to the foregoing embodiment, the LED boards 24 and the light guide plate 28 are housed in the backlight chassis 32, and the spacer members 20 are fixed to the backlight chassis 32 through the LED boards 24. Thus, the spacer members 20 can be stably disposed between the LED boards 24 and the light guide plate 28. Accordingly, the distance D1 between the LED boards 24 and the light guide plate 28, and warping or floating of the LED boards 24 can be effectively regulated by the spacer members 20.

### Second Embodiment

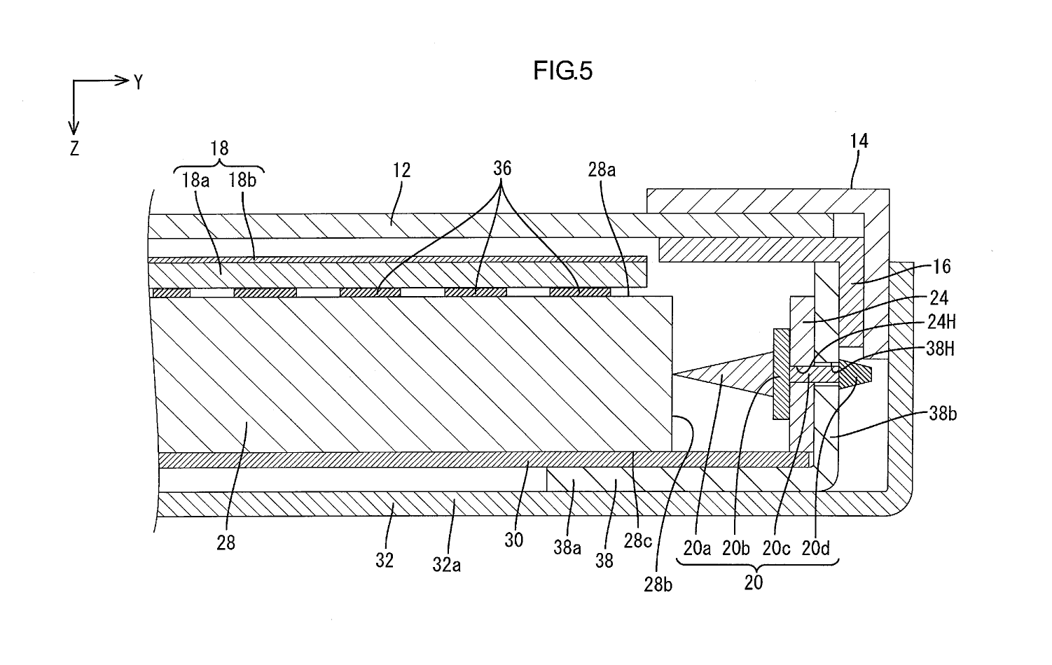

FIG. 5 is an enlarged cross section view of a backlight unit 34 around spacer members 20 according to a second embodiment. The second embodiment differs from the first embodiment in that the backlight unit 34 includes a heat dissipating plate 38. In other respects, the second embodiment is similar to the first embodiment. Thus, similar constituent members are designated with the same reference signs and the description of their structure, operation, and effect will be omitted.

In the backlight unit 34 according to the second embodiment, the heat dissipating plate 38 is disposed on the back side of the LED boards 24. The heat dissipating plate 38 includes a bottom surface portion 38a, and a side surface portion 38b rising from the outer end of the bottom surface portion 38a on one long side thereof, forming an L-shape in a horizontal cross section. The heat dissipating plate 38 is disposed along the long side direction of a backlight chassis 32. The bottom surface portion 38a of the heat dissipating plate 38 is fixed to a bottom plate 32a of the backlight chassis 32. The spacer members 20 are attached to the heat dissipating plate 38 via through holes 24H and heat dissipating plate through holes 38H formed in the heat dissipating plate 38. Thus, the spacer members 20 are fixed to the backlight chassis 38 via the heat dissipating plate 38. The heat dissipating plate 38 dissipates the heat accumulated in the LED boards 24 to the outside of the backlight unit 34. Accordingly, the heat transmitted to the light guide plate 28 can be decreased, and therefore, the thermal expansion of the light guide plate 28 or the thermal deformation of the LED boards 24 can be decreased.

### Third Embodiment

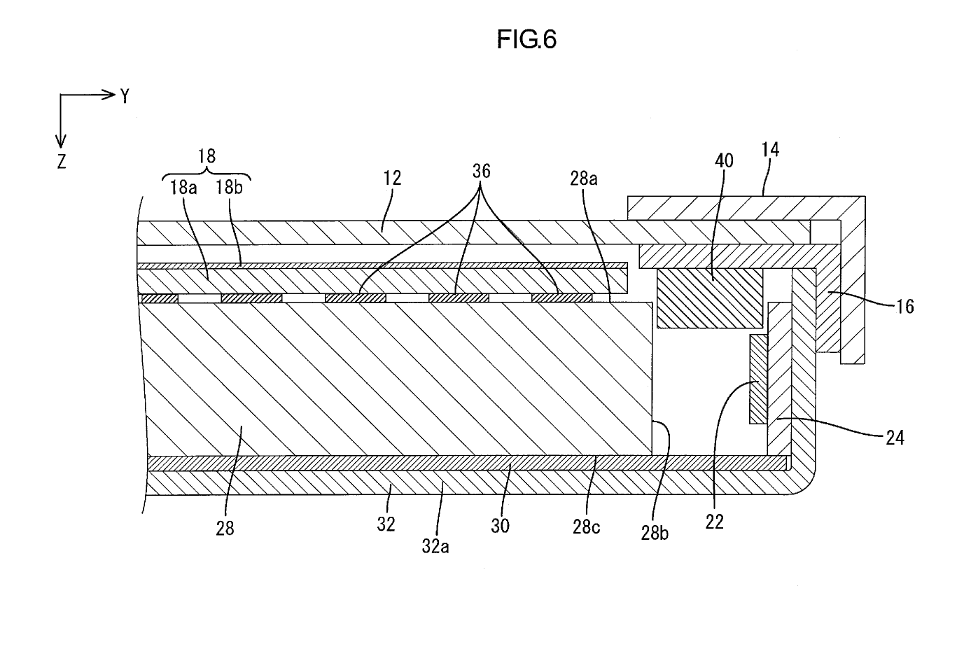

FIG. 6 is an enlarged cross section view of a backlight unit 34 around a spacer member 40 according to a third embodiment. The third embodiment differs from the first embodiment in the disposition and shape of the spacer member 40 and is similar to the first embodiment in other respects. Thus, similar constituent members are designated with the same reference signs and the description of their structure, operation, and effect will be omitted.

In the backlight unit 34 according to the third embodiment, the spacer member 40 has a rectangular shape with one surface fixed to only a surface of a frame 16 positioned between LED boards 24 and a light guide plate 28 on the side of light entrance surfaces 28b with respect to a LED light sources 22. The spacer member 40 may be fixed to the surface of the frame 16 via an adhesive tape. Thus, the spacer member 40 can be stably disposed between the LED boards 24 and the light guide plate 28. Accordingly, the distance D1 between the LED boards 24 and the light guide plate 28, and warping or floating of the LED boards 24 can be effectively regulated by the spacer member 40. Further, a plurality of LED light sources 22 can be disposed on the surface of the LED boards 24 continuously because the spacer member 40 is not disposed on the surface of the LED boards 24. The spacer member 40 has a surface facing the light guide plate 28 with a predetermined gap and is parallel to the light guide plate 28. The spacer member 40 also has a surface facing the LED boards 24 with a predetermined gap between the spacer member 40 and the LED boards 24 and is parallel to the LED boards 24. Thus, the distance between the LED light sources 22 and the light guide plate 28 can be maintained in a predetermined range by the spacer members 20.

In the backlight unit 34 according to the third embodiment, the spacer member 40 may face the light guide plate 28 to be parallel to each other such that the spacer member 40 and the light guide plate 28 have a surface to surface contact with each other. In this way, a large area of contact can be obtained between the spacer member 40 and the light guide plate 28. Accordingly, the distance D1 between the LED boards 24 and the light guide plate 28 can be effectively regulated by the spacer member.

### Fourth Embodiment

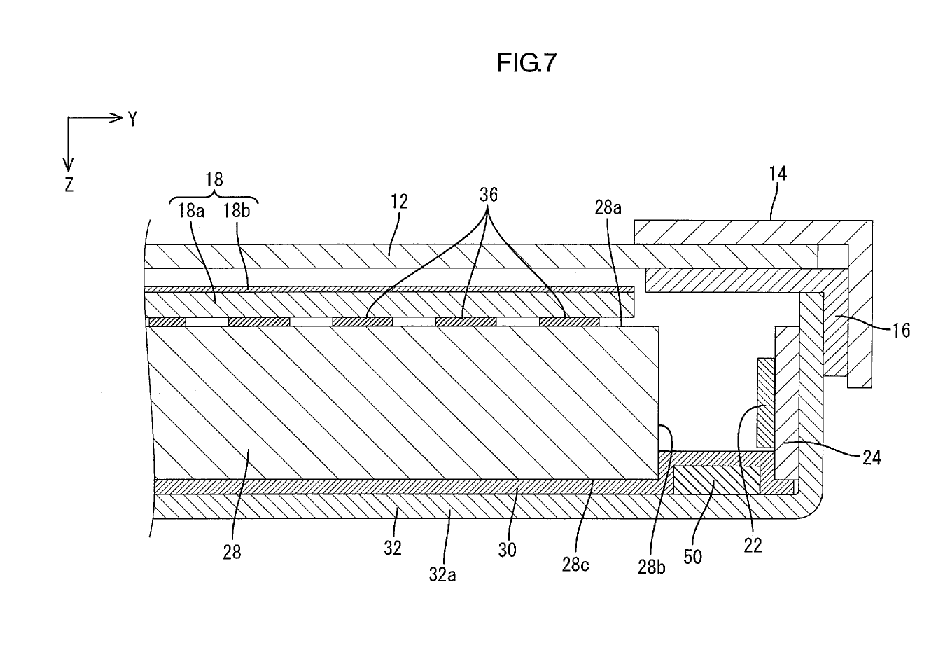

FIG. 7 is an enlarged cross section view of a backlight unit 34 around a spacer member 50 according to a fourth embodiment. The fourth embodiment differs from the third embodiment in the disposition of the spacer member 50 and is similar to the third embodiment in other respects. Thus, similar constituent members are designated with the same reference signs and the description of their structure, operation, and effect will be omitted.

In the backlight unit 34 according to the fourth embodiment, the spacer member 50 has a rectangular shape with one surface fixed to only a surface of a backlight chassis 32 positioned between LED boards 24 and a light guide plate 28 on the side of a surface 28c opposite to LED light sources 22. The spacer member 50 is covered with a light reflection sheet 30. The spacer member 50 may be fixed to the surface of the backlight chassis 32 via, for example, an adhesive tape. In this configuration, the spacer member 50 can be stably disposed between the LED boards 24 and the light guide plate 28. Thus, the distance D1 between the LED boards 24 and the light guide plate 28, and warping or floating of the LED boards 24 can be effectively regulated by the spacer member 50. Since the spacer member 50 is covered with the light reflection sheet 30, the light can be reflected around the spacer member 50 even when the spacer member 50 is fixed to the surface of the backlight chassis 32 positioned between the LED boards 24 and the light guide plate 28.

### Fifth Embodiment

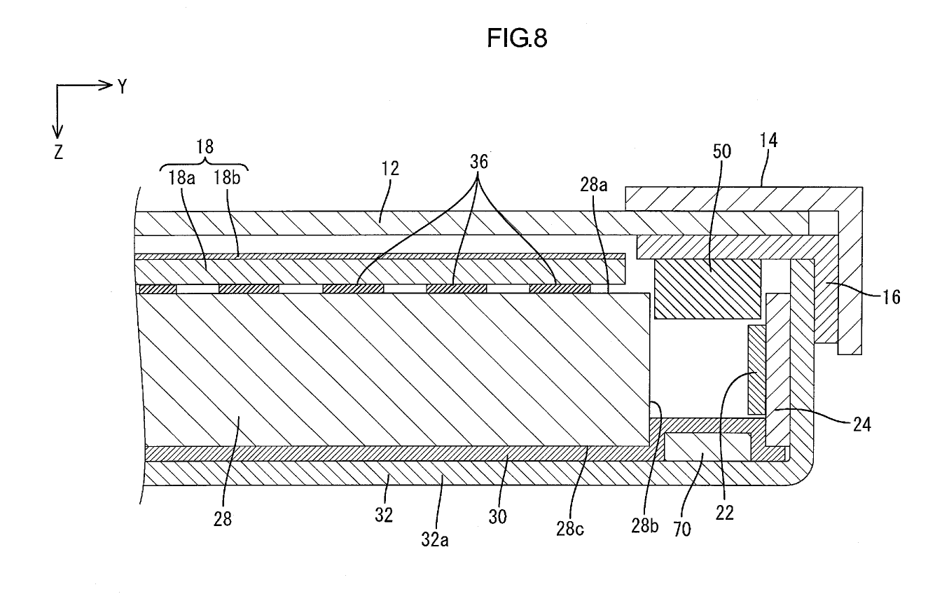

FIG. 8 is an enlarged cross section view of a backlight unit 34 around spacer members 60 and 70 according to a fifth embodiment. The fifth embodiment is a combination of the configuration of the third embodiment and the configuration of the fourth embodiment. The fifth embodiment is similar to the third embodiment and the fourth embodiment other than the spacer members 60 and 70. Thus, similar constituent members are designated with the same reference signs and the description of their structure, operation, and effect will be omitted.

In the backlight unit 34 according to the fifth embodiment, the two spacer members 60 and 70, each of which has a rectangular shape, are disposed between LED boards 24 and a light guide plate 28. One spacer member 60 has one surface fixed to only a surface of a frame 16 positioned on the side of a light exit surface 28a with respect to the LED light sources 22. The other spacer member 70 has one surface fixed to only a surface of the frame 16 positioned on the side of a surface 28c opposite to the LED light sources 22. Because of the two spacer members 60 and 70 fixed to the surface of the frame 16 and the surface of the backlight chassis 32, respectively, the distance D1 between the LED boards 24 and the light guide plate 28, and warping or floating of the LED boards 24 can be more effectively regulated by the spacer members 60 and 70.

### Sixth Embodiment

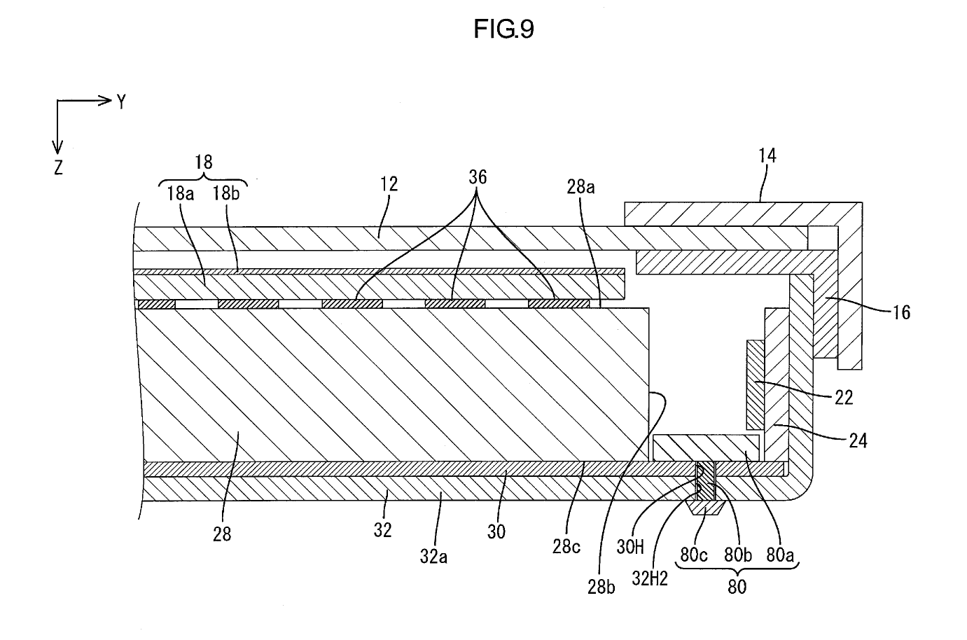

FIG. 9 is an enlarged cross section view of a backlight unit 34 around a spacer member 80 according to a sixth embodiment. The sixth embodiment differs from the fourth embodiment in the method of fixing the spacer member 80 and the disposition of a light reflection sheet 30. In other respects, the sixth embodiment is similar to the fourth embodiment. Thus, similar constituent members are designated with the same reference signs and the description of their structure, operation, and effect will be omitted.

In the backlight unit 34 according to the sixth embodiment, a second mounting hole 32H2 is formed in a bottom plate 32a of a backlight chassis 32. In the reflection sheet 30, a reflection sheet through hole 30H, penetrating the reflection sheet, communicated with the second mounting hole 32H2 in the backlight chassis 32 is formed at a position overlapping with the second mounting hole 32H2. The spacer member 80 includes a main body 80a, a penetrating portion 80b, and a locking portion 80c. The main body 80a has a rectangular shape and regulates the distance between LED boards 24 and a light guide plate 28. The penetrating portion 80b has an axial shape and penetrates the second mounting hole 32H2 formed in the backlight chassis 32. The locking portion 80c is continuous with the penetrating portion 80b and is locked on the bottom plate 32a of the backlight chassis 32. The spacer member 80 is fixed to the backlight chassis 32 via the penetrating portion 80b and the locking portion 80c. In this configuration, the spacer member 80 can be stably disposed between the LED boards 24 and the light guide plate 28, and therefore, the distance D1 between the LED boards 24 and the light guide plate 28, and warping or floating of the LED boards 24 can be effectively regulated by the spacer member 80.

### Seventh Embodiment

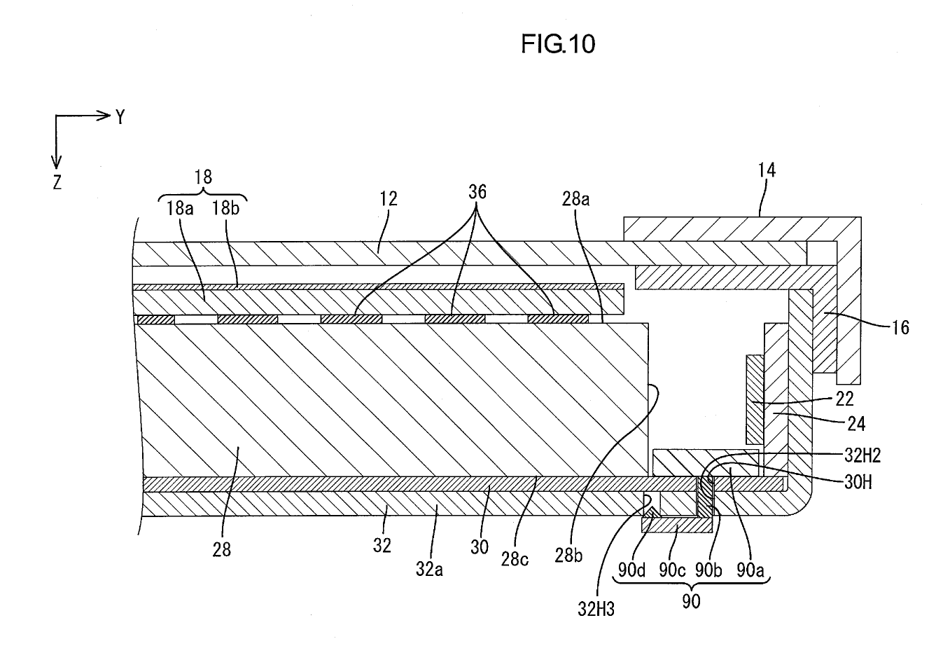

FIG. 10 is an enlarged cross section view of a backlight unit 34 around a spacer member 90 according to a seventh embodiment. The seventh embodiment differs from the sixth embodiment in the method of fixing the spacer member 90 and is similar to the sixth embodiment in other respects. Thus, similar constituent members are designated with the same reference signs and the description of their structure, operation, and effect will be omitted.

In the backlight unit 34 according to the seventh embodiment, an mounting hole 32H3 is further formed in a bottom plate 32a of a backlight chassis 32. The spacer member 90 includes a main body 90a, a penetrating portion 90b, a first locking portion 90c, and a second locking portion 90d. The main body 90a has a rectangular shape and regulates the distance between LED boards 24 and a light guide plate 28. The penetrating portion 90b has an axial shape and penetrates a second mounting hole 32H2 formed in the backlight chassis 32. The first locking portion 90c is continuous with the penetrating portion 90b and extends along the back surface of the bottom plate 32a of the backlight chassis 32 to the third mounting hole 32H3. The second locking portion 90d is continuous with the first locking portion 90c and has a pointed tip shape. As the distal end of the first locking portion 90c is engaged in the third mounting hole 32H3, the first locking portion 90c is locked on the bottom plate 32a of the backlight chassis 32. The spacer member 90 is fixed to the backlight chassis 32 via the penetrating portion 90b, the first locking portion 90c, and the second locking portion 90d. In this configuration, the spacer member 90 can be stably disposed between the LED boards 24 and the light guide plate 28, and therefore, the distance D1 between the LED boards 24 and the light guide plate 28, and warping or floating of the LED boards 24 can be effectively regulated by the spacer member 90.

Correspondence between the configurations of the embodiments and a configuration of the present invention is described below. The LED light sources 22 are an example of a “light source”. The LED boards 24 are an example of a “light source board”. The backlight unit 34 is an example of a “lighting device”.

Modifications of the foregoing embodiments are listed below.

(1) While in the foregoing embodiments the backlight unit has adopted the edge light type, the backlight unit may adopt other types.

(2) While the foregoing embodiments have adopted the configuration in which the spacer member is provided as a separate member from the LED board, the frame, and the backlight chassis, a configuration may be adopted in which the spacer member is integrally formed with the LED board, the frame, or the backlight chassis.

(3) The disposition, mode, number, method of attaching and the like of the spacer member may be appropriately modified from the foregoing embodiments.

(4) While in the foregoing embodiments a liquid crystal display device using a liquid crystal panel as a display panel has been described byway of example, the present invention may be applied to display devices using other types of display panel.

(5) While in the foregoing embodiments a television receiver provided with a tuner has been described by way of example, the present invention may be applied to a display device not provided with a tuner.

While embodiments of the present invention have been described in detail, these embodiments are merely exemplary and do not limit the scope of the claims. The technologies recited in the claims may include various modifications and changes made to the embodiments described above by way of example.

The technical elements described in the present specification or drawings may provide their technical utility individually or in various combinations, and are not limited to the combinations recited in the claims as filed. The technologies described in the present specification or drawings by way of example may achieve a plurality of objects at the same time, and may provide technical utility when any one of the objects is achieved.

### EXPLANATION OF SYMBOLS

TV: Television receiver

Ca, Cb: Cabinet

T: Tuner

S: Stand

10: Liquid crystal display device

12: Liquid crystal panel

14: Bezel

16: Frame

18: Optical member

20, 40, 50, 60, 70, 80, and 90: Spacer member

22: LED light source;

24: LED board

26: LED unit

28: Light guide plate

30: Light reflection sheet

32: Backlight chassis

32a: Bottom plate

32b, 32c: Side plate

34: Backlight unit

36: Scattering dot

38: Heat dissipating plate

1. A lighting device comprising:
a light source board;
a light source disposed on a surface of the light source board;
a light guide plate configured to guide light from the light source; and
a spacer member configured to regulate a distance between the light source board and the light guide plate.

2. The lighting device according to claim 1, wherein:
the light guide plate includes a light entrance surface on a side thereof;
the light source board faces the light entrance surface of the light guide plate; and
the spacer member is in contact with the light entrance surface of the light guide plate.

3. The lighting device according to claim 1, wherein the spacer member is in contact with a surface of the light source board.

4. The lighting device according to claim 1, wherein the spacer member has a coefficient of linear expansion smaller than a coefficient of linear expansion of the light guide plate.

5. The lighting device according to claim 1, wherein the spacer member includes a surface facing the light source board and parallel to the light source board.

6. The lighting device according to claim 1, wherein:
the spacer member includes a pointed tip portion; and
the pointed tip portion faces the light guide plate.

7. The lighting device according to claim 6, wherein:
the light source includes a plurality of light sources disposed parallel to each other on the light source board; and
the spacer member is disposed between the adjacent light sources.

8. The lighting device according to claim 1, wherein the spacer member includes a surface facing the light guide plate and parallel to the light guide plate.

9. The lighting device according to claim 1, further comprising a retainer member configured to retain at least the light source and the light guide plate,
wherein the spacer member is fixed to the retainer member through the light source board.

10. The lighting device according to claim 1, further comprising a retainer member configured to retain at least the light source and the light guide plate,
wherein the spacer member is disposed only on a surface of the retainer member positioned between the light source board and the light guide plate and fixed to the retainer member.

11. The lighting device according to claim 10, wherein:
the light guide plate includes a light exit surface on a plate surface of the light guide plate and through which light from the light source entered via the light entrance surface exits to the outside, and an opposite surface on a side opposite to the light exit surface; and
the spacer member is fixed to a surface of the retainer member on a side of the light exit surface with respect to the light source.

12. The lighting device according to claim 10, wherein:
the light guide plate includes a light exit surface through which light from the light source entered via the light entrance surface exits to the outside, the light exit surface on a plate surface of the light guide plate, and an opposite surface on a side opposite to the light exit surface; and
the spacer member is fixed to a surface of the retainer member closer to the opposite surface than the light source.

13. The lighting device according to claim 1, further comprising a heat dissipating plate disposed on a back surface side of the light source.

14. The lighting device according to claim 1, wherein the light source is a light-emitting diode.

15. The lighting device according to claim 14, wherein the light-emitting diode is a blue light emitting element coated with a phosphor with an emission peak in a yellow region so as to emit white light.

16. The lighting device according to claim 14, wherein the light-emitting diode is a blue light emitting element coated with a phosphor with emission peaks in green and red regions so as to emit white light.

17. The lighting device according to claim 14, wherein the light-emitting diode is a blue light emitting element coated with a phosphor with an emission peak in a green region and combined with a red light emitting element so as to emit white light.

18. The lighting device according to claim 14, wherein the light-emitting diode is a blue light emitting element combined with a green light emitting element and a red light emitting element so as to emit white light.

19. The lighting device according to claim 14, wherein the light-emitting diode is an ultraviolet light emitting element combined with a phosphor.

20. The lighting device according to claim 14, wherein the light-emitting diode is an ultraviolet light emitting element coated with a phosphor with emission peaks in blue, green, and red so as to emit white light.

21. A display device comprising a display panel configured to display by utilizing light from the lighting device according to claim 1.

22. The display device according to claim 21, wherein the display panel is a liquid crystal panel including liquid crystal.

23. A television receiver comprising the display device according to claim 21.
